(19) United States
(12) Patent Application Publication
(10) Pub. No.: US 2005/0208852 A1
(43) Pub. Date: Sep. 22, 2005

(54) Roofing membranes

(75) Inventor: Manfred Weber, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/067,713

(22) Filed: Mar. 1, 2005

(30) Foreign Application Priority Data
Mar. 17, 2004 (DE) 10 2004 013 390.5

(51) Int. Cl. B32B 3/00; B32B 5/02; B32B 9/00; B32B 27/04; B32B 27/12; B32B 27/02; D04H 1/00; D04H 3/00; D04H 5/00; D04H 13/00

(52) U.S. Cl. 442/65; 442/152; 442/164

(57) ABSTRACT

A roofing membrane based on a bonded fibrous web coated with bitumen on both sides and consolidated with a mixture of at least one polymeric binder and an aluminum hydroxide and the use of a bonded fibrous web consolidated with a mixture of at least one polymeric binder and at least one aluminum hydroxide as a base material for a bituminized roofing membrane.

This invention relates to roofing membranes comprising bonded fibrous webs coated with bitumen on both sides.

DE-A-27 42 208 discloses fibrous webs which are consolidated by means of a binder which consists of a mixture of an emulsion polymer and of an inert reinforcing filler. The polymer is used in amounts of from 2% to 400% by weight, based on the fibrous web, and the filler is used in amounts from 5% to 80% by weight. The fillers mentioned are clay, calcium carbonate, talcum, precipitated barium sulfate, aluminum oxide hydrate, pyrites, gypsum, magnesium silicate, magnesium carbonate, mica and silicon dioxide. The essential function of these fillers is to lower the costs of the bonded fibrous web. The webs are used for example in the apparel sector, as cleaning cloths, for padding packages, as filters and packings and seals for machines.

EP-A-0 442 370 describes nonwovens bound or bonded together by a polymer which comprises carboxyl groups and which is present as an aqueous dispersion having an average particle size in the range from 20 to 400 nm and which is crosslinked by means of magnesium, calcium or zinc in the form of the oxides, hydroxides, carbonates or bicarbonates and also mixtures thereof. The binder may if appropriate further comprise a resol or an amino resin. The bonded fibrous webs are used in bituminized form as roofing membranes.

Also known are formaldehyde-free polymer binders for consolidating fibrous webs. For instance, U.S. Pat. No. 4,076,917 describes binders comprising addition polymers having carboxylic acid or anhydride groups and β-hydroxyalkylamides as crosslinkers.

EP-A 0 445 578 discloses panels composed of finely divided materials such as glass fibers which are consolidated by means of binder mixtures of high molecular weight polycarboxylic acids and polyhydric alcohols, alkanolamines or polyamines.

Further formaldehyde-free, aqueous binders for producing consolidated fibrous webs, especially webs composed of glass fibers, are known from EP-A-0 583 086. The binders comprise a polycarboxylic acid having at least two carboxyl or anhydride groups, at least one polyol and a phosphorus compound as an accelerator. According to EP-A-0 651 088, such binder mixtures are used for consolidating cellulosic substrates.

WO-A-97/31036 discloses formaldehyde-free, aqueous binders for fibrous webs, especially for webs composed of glass fibers. The binders comprise (A) an addition polymer containing from 5% to 100% by weight of units derived from an ethylenically unsaturated acid anhydride or from an ethylenically unsaturated dicarboxylic acid whose carboxyl groups are capable of forming an anhydride group, and (B) an alkanolamine having at least two hydroxyl groups, and also a phosphorus compound as a reaction accelerant. The bonded fibrous webs are used for example to produce roofing membranes, insulating materials, floor coverings and pot cleaners.

DE-A-196 21 573 discloses thermally curable, aqueous compositions comprising a hydroxyalkylated polyamine and a free-radically polymerizable polymer containing from 5% to 100% by weight of units derived from at least one ethylenically unsaturated mono- or dicarboxylic acid. Uses for such mixtures include as binders for fibrous webs.

EP-A-0 976 866 discloses textile fabrics comprising a web of fibers joined together by means of a polymeric binder. The textile fabric further comprises from 1% to 20% by weight of an oxide and/or hydroxide of Al, B, Si, Mg, Ti and/or Zn in a state of colloidally disperse subdivision and also a sulfosuccinate or sulfosuccinamate as a wetting agent. The additives improve the water-absorbing properties of the textile fabrics, their hydrophilicity surviving repeated washing.

It is an object of the present invention to provide roofing membranes which comprise a bonded fibrous web and which possess improved thermal stability and dry breaking strength compared with existing roofing membranes.

We have found that this object is achieved according to the present invention by a roofing membrane based on a bonded fibrous web coated with bitumen on both sides and consolidated with a mixture of at least one polymeric binder and an aluminum hydroxide.

The fibrous webs can consist of natural and/or synthetic fibers. Examples of natural fibers are cellulose fibers of differing origin, such as chemical pulp and viscose rayon staple and also fibers composed of cotton, hemp, jute, sisal and wood, wool and also blends of two or more thereof. Preferred fibers from this group are fibers of jute, sisal and wood.

Examples of synthetic fibers are viscose, polyester, polyamide, polypropylene, polyethylene, polyacrylonitrile and polyvinyl chloride fibers, carbon fibers, glass fibers, ceramic fibers and mineral fibers and also blends of two or more thereof. The bonded fibrous webs are preferably produced using polyester fibers and also blends of polyester fibers and glass fibers.

Polyester fibers can also be melt spun from recycled material and used for producing a web useful as a base material. The webs can consist for example of staple fibers or of spun fibers and also of blends thereof. As will be known, they are produced mechanically by needling or hydroentangling a wet- or dry-laid web and by chemical consolidation with polymeric binders. Bonded fibrous webs are produced for example using at least one binder in an amount from 0.5% to 30% and preferably from 15% to 20% by weight, based on the solids content of the binder and of the sheetlike fibrous structures such as webs. The binder serves to consolidate the webs. It can be applied for example by spraying, dipping, impregnating or padding or by treating the fibrous structure with a foam.

The basis weight of the webs is for example in the range from 50 to 2000 g/m² and preferably in the range from 50 to 1600 g/m². The basis weight of unconsolidated webs is usually in the range from 80 to 300 g/m².

Polymeric binders for consolidating webs or, in other words, for producing bonded fibrous webs are known. For instance, thermally curable binders for consolidating fibrous webs are described in the following printed publications, which are hereby incorporated herein by reference: U.S. Pat. No. 4,076,917, EP-A-0 445 578, EP-A-0 583 086, EP-A-0 651 088, WO-A-97/31036 page 4 line 12 to page 12 line 14, WO-A-97/31059 page 2 line 22 to page 12 line 5, WO-A-97/31060 page 3 line 8 to page 12 line 36, DE-A-199 49 591 page 3 line 5 to page 7 page 38, WO-A-01/27163 page 5 line 34 to page 22 line 2 and also the radiation-curable binders known from DE-A-199 17 965.

Useful thermally curable binders in addition to the binders described in the above-cited printed publications include all curable binders which have been described for consolidating fibrous webs in the literature and/or which are used commercially for this purpose, such as thermally curable resins based on phenol and formaldehyde, melamine-formaldehyde resins, urea-formaldehyde resins, one- and two-component systems based on epoxy resins or polyurethanes, polyacrylates, polymethacrylates, polyvinyl acetates, styrene-acrylate copolymer dispersions, styrene-methacrylate copolymer dispersions, styrene-butadiene-(meth)acrylic acid copolymer dispersions and also mixtures thereof with a mixture of a polycarboxylic acid and a polyhydric alcohol as a crosslinking component.

Examples of preferred thermally curable binders are mixtures of
(a) an addition polymer which is obtainable by free-radical addition polymerization and which comprises from 5% to 100% by weight of interpolymerized units derived from an ethylenically unsaturated carboxylic anhydride or from an ethylenically unsaturated dicarboxylic acid whose carboxylic acid groups are capable of forming an anhydride group, and
(b) at least one alkanolamine which comprises at least two hydroxyl groups in the molecule.

Specific examples of such mixtures are about 40-60% by weight of solids aqueous solutions of an 80% by weight acrylic acid and 20% by weight maleic acid addition copolymer having a molar mass M_{w} from 15 000 to 900 000 in combination with triethanolamine or aqueous solutions of a 55% by weight acrylic acid and 45% by weight maleic acid addition copolymer in combination with triethanolamine. These binders may if appropriate an esterification catalyst and/or bound phosphorus compound such as hypophosphorous acid as a reaction accelerant.

The above-described addition copolymer (a) may also for example be polymerized from
50% to 99.5% of at least one ethylenically unsaturated mono- or dicarboxylic acid,
0.5% to 50% by weight of at least one ethylenically unsaturated compound selected from the group of the esters of ethylenically unsaturated monocarboxylic acids and the monoesters and the diesters of ethylenically unsaturated dicarboxylic acids with an amine comprising at least one hydroxyl group, and
up to 20% by weight of some other monomer.

Thermally curable, aqueous compositions which comprise at least one copolymer (a) and at least one alkanolamine or a more highly functional α-hydroxyalkylamine may if appropriate further comprise at least one surfactant.

Further thermally curable binders are based on aqueous mixtures of
polycarboxylic acids such as polyacrylic acid, polymethacrylic acid, addition copolymers of acrylic acid and maleic acid, addition copolymers of methacrylic acid and maleic acid, addition copolymers of ethylene and maleic acid, styrene and maleic acid, or addition copolymers of acrylic acid or methacrylic acid and esters of acrylic or methacrylic acid with preferably monohydric alcohols containing from 1 to 24 carbon atoms, the polycarboxylic acids having a K value in the range from 50 to 100 (measured in nonneutralized form of the polycarboxylic acids by the method of H. Fikentscher in dimethylformamide at 25° C. and a polymer concentration of 0.1% by weight)
polyhydric alcohols such as trimethylolpropane, glycerol, 2-hydroxymethyl-1,4-butanediol or polyvinyl alcohols and/or polyamines and/or alkanolamines.

Polycarboxylic acids, polyhydric alcohols, alkanolamines and polyamines are preferably used in such amounts that the number of acid function is equivalent to the total number of alcoholic hydroxyl and amine functions, cf. EP-A-0 445 578. It is also possible to use binders which consist of an aqueous solution of a polycarboxylic acid (addition homo- or copolymer) preferably with a molar mass of M_{w} of 10 000 or less and a polyol such as triethanolamine and where the ratio of the equivalents of hydroxyl groups to equivalents of carboxyl groups is in the range from 0.4:1 to 1.0:1, cf. EP-A-0 990 727.

Also advantageous are the binders known from EP-A-0 442 370 page 2 line 55 to page 17 line 47 which comprise a polymer which comprises carboxyl groups and is present as an aqueous dispersion having an average particle size in the range from 20 to 400 nm and which is crosslinked by means of magnesium, calcium or zinc in the form of the oxides, hydroxides, carbonates or bicarbonates and also mixtures thereof. These binders may if appropriate further comprise a phenol-formaldehyde condensate, a melamine-formaldehyde resin or a urea-formaldehyde resin.

The polymeric binder used is preferably an aqueous dispersion of a thermally crosslinkable addition copolymer of acrylic esters, styrene and acrylonitrile that is available from BASF Aktiengesellschaft under the designation Acronal® S 888 S. Particular preference is given to using polymeric binders comprising a thermally crosslinkable addition copolymer of acrylic esters, styrene and acrylonitrile in combination with a urea-formaldehyde resin and/or a melamine-formaldehyde resin. Such mixtures comprise for example from 4% to 20% and preferably from 6% to 16% by weight of at least one resin.

Useful binders for consolidating webs further include the products which BASF Aktiengesellschaft markets under the Acrodur® trademark. For instance, Acrodur® DS 3558 X is a formaldehyde-free binder for fibers and granular materials. It consists of an aqueous styrene-acrylate dispersion modified with a polycarboxylic acid and a polyhydric alcohol as a crosslinking component. It crosslinks at a temperature as low as 130° C. To achieve high manufacturing speeds, however, crosslinking is preferably carried out at temperatures in the range from 180 to 200° C. Acrodur®) 950 L, which is commercially available as a colorless or slightly yellow, clear, aqueous solution of a modified polycarboxylic acid with a polyhydric alcohol as crosslinking component, is a further formaldehyde-free binder for wood fibers, natural fibers and cork and is also suitable for consolidating glass and mineral fibers. It crosslinks at drying temperatures of about 160-180° C. To achieve a high degree of crosslinking, it comes with the recommendation that the manufacturing speed be optimized as a function of crosslinking time and crosslinking temperature.

The binders used are preferably low-formaldehyde or formaldehyde-free thermally curable products. Low-formaldehyde is to be understood in the present context as meaning that the binders do not include significant amounts of free formaldehyde and that no significant amounts of formaldehyde are released in the course of the drying or curing of the binder-treated materials either. In general, such binders include <100 ppm of formaldehyde.

Particular preference is given to formaldehyde-free binders comprising at least one polycarboxylic acid and at least one polyhydric alcohol and/or alkanolamine or polyamine. Compositions comprising these binders may if appropriate further comprise further formaldehyde-free binders, for example polyacrylates marketed by BASF Aktiengesellschaft under the Acronal® trademark.

All curable binders which are known for binding/bonding fibrous webs and which are referred to above can be used as a binder for fibrous webs. It is also possible to use mixtures of at least one curable binder and at least one other binder.

To increase the breaking strength and thermal stability of webs, the present invention utilizes a mixture of a polymeric binder and at least one aluminum hydroxide. The mixture comprises for example from 10 to 100 and preferably from 15 to 50 parts by weight of aluminum hydroxide (reckoned 100% pure) per 100 parts by weight of a polymeric binder (reckoned 100% pure). As aluminum hydroxide there can be used for example hydrargillite (α-Al(OH)₃), bayerite (β-Al(OH)₃), nordstrandite (γ-Al(OH)₃) and oxide hydroxides such as boehmite (α-AlO(OH)) and diaspore (β-AlO(OH)) and also mixtures thereof. It is also advantageous to use aluminum hydroxide precipitated from water-soluble aluminum salts. The average particle diameter of the aluminum hydroxides is for example in the range from 0.5 to 50 μm and preferably in the range from 0.9 to 5 μm. It will be appreciated that it is possible to use a mixture of various aluminum hydroxides.

To consolidate laid webs, they are treated for example with a mixture of a polymeric binder and an aluminum hydroxide or they are initially treated with a binder, if appropriate dried and then have the aluminum hydroxide applied to them before the web thus treated is heated to a temperature in the range from 180 to 230° C. for consolidation. However, it is also possible to apply the aluminum compound first and the polymeric binder second and then to dry the impregnated web and subsequently crosslink the binder.

The webs impregnated with a binder are heated to temperatures in the range from 180 to 230° C. and preferably in the range from 190 to 210° C. for consolidation. The duration of the heating step depends essentially on the temperature, the water content and the particular fiber making up the web. Usually, the webs impregnated or coated with at least one binder are dried from 0.5 to 5 and preferably 1.3 to 3 minutes at a temperature in the temperature range indicated above. Initially water vapor escapes during heating, and concurrently or subsequently the thermally curable binder is crosslinked.

The invention also provides for the use of a bonded fibrous web consolidated with a mixture of at least one polymeric binder and at least one aluminum hydroxide as a base material for a bituminized roofing membrane.

The roofing membranes are obtained by the consolidated webs described above being coated or impregnated with bitumen on both sides. For example, a continuous sheet of a suitable web is led through a bitumen melt and the web thus impregnated is squeezed off. This operation can be repeated one or more times. Bitumen add-on, based on the consolidated web, is for example in the range from 1000% to 3500% by weight and preferably in the range from 1700% to 2800% by weight. The roofing membranes also comprise bonded assemblies of fibrous webs consolidated with a mixture of at least one polymeric binder and at least one aluminum hydroxide. Such bonded assemblies are obtained when, for example, two webs each coated with bitumen are welded together with or without an interlaid web consolidated with a mixture of at least one polymeric binder and at least one aluminum hydroxide.

The roofing membranes of the present invention surprisingly have higher thermal stability and higher breaking strength than existing roofing membranes. In addition, they are flame retardant and less costly than roofing membranes where the base material web comprises a web consolidated exclusively with a polymeric binder.

In the examples, parts and percentages are by weight.

### EXAMPLES

The following materials were used:
Binder A: mixture of 80 parts of a 49.5% aqueous dispersion of a thermally crosslinkable addition copolymer of acrylic esters, styrene and acrylonitrile (Acronal S 888 S) and 20 parts of a 40% aqueous urea-formaldehyde resin (Urecoll® A)
Binder 1: mixture of 100 parts of binder A and 5 parts of an aluminum hydroxide (hydrargillite) having an average particle diameter of 1.2 μm (Apyral® 60 D, from Nabaltec)
Binder 2: mixture of 100 parts of binder A and 10 parts of aluminum hydroxide (Apyral®D 60 D)
Binder 3: mixture of 100 parts of binder A and 15 parts of aluminum hydroxide (Apyral® 60 D)
Binder 4: mixture of 100 parts of binder A and 20 parts of aluminum hydroxide (Apyral® 60 D)
Binder 5: mixture of 100 parts of binder A and 25 parts of aluminum hydroxide (Apyral® 60 D)
Binder 6: mixture of 100 parts of binder A and 10 parts of calcium carbonate (Omyacarb® Extra CL)
Binder 7: mixture of 100 parts of binder A and 10 parts of kaolin (Speswhite®)

### Inventive Examples 1 to 5

A base material web having a basis weight of 150 g/m² was impregnated with each of the binder mixtures indicated in the table. The add-on of polymeric binder and aluminum hydroxide was always 20%, based on the solids of the binder mixture and on the dry fibrous web. The liquor concentration of the binder preparations was adjusted to 10% in each case. The impregnated webs were dried at a temperature of 200° C. for 3 minutes. Thereafter, the breaking strength of the bonded webs was determined at room temperature in accordance with German industrial specification DIN 52 123 and the thermal stability at 200° C. in accordance with German industrial specification DIN 18 192 under a weight loading of 4 kg. The results obtained are reported in the table together with the results of the comparative examples described hereinbelow.

### Comparative Example 1

Inventive example 1 was repeated except for the single difference that the polymeric binder was used without further additive.

### Comparative Example 2

Inventive example 2 was repeated except for the single difference that 10 parts of calcium carbonate were used instead of aluminum hydroxide.

### Comparative Example 3

Inventive example 2 was repeated except for the single difference that 10 parts of kaolin were used instead of aluminum hydroxide.

TABLE

| | | Binder | Breaking strength | | Binder | Thermal stability at 200° C. | |
|---|---|---|---|---|---|---|---|
| | Binder | add-on [g/m²] | F max [N/5 cm] | D max | add-on [g/m²] | Web lengthening [%] | Web shortening [%] |
| Inventive | | | | | | | |
| example | | | | | | | |
| 1 | 1 | 192 | 602 | 42 | 188 | +2.4 | −2.3 |
| 2 | 2 | 196 | 589 | 44 | 194 | +2.2 | −1.9 |
| 3 | 3 | 193 | 574 | 43 | 194 | +2.3 | −2.2 |
| 4 | 4 | 191 | 585 | 45 | 191 | +2.4 | −2.0 |
| 5 | 5 | 191 | 583 | 45 | 188 | +2.2 | −1.9 |
| Comparative | | | | | | | |
| examples | | | | | | | |
| 1 | A | 194 | 600 | 40 | 190 | +2.3 | −2.3 |
| 2 | 6 | 191 | 517 | 41 | 189 | +2.9 | −3.1 |
| 3 | 7 | 193 | 569 | 45 | 195 | +2.5 | −2.5 |

1. A roofing membrane based on a bonded fibrous web coated with bitumen on both sides and consolidated with a mixture of at least one polymeric binder and an aluminum hydroxide.

2. The roofing membrane according to claim 1 wherein the fibrous web consists of natural and/or synthetic fibers.

3. The roofing membrane according to claim 1 or 2 wherein the fibrous web comprises at least one natural fiber selected from the group consisting of chemical pulp and viscose rayon staple and also fibers of cotton, hemp, jute, sisal and wood, wool and also blends of two or more thereof.

4. The roofing membrane according to claim 1 or 2 wherein the fibrous web comprises at least one synthetic fiber selected from the group consisting of viscose, polyester, polyamide, polypropylene, polyethylene, polyacrylonitrile and polyvinyl chloride fibers, carbon fibers, glass fibers, ceramic fibers and mineral fibers and also blends of two or more thereof.

5. The roofing membrane according to any one of claims 1 to 4 wherein the aluminum hydroxide comprises hydrargillite, bayerite, nordstrandite, boehmite, diaspore and/or aluminum hydroxide precipitated from water-soluble aluminum salts.

6. The roofing membrane according to any one of claims 1 to 5 wherein the bonded web is consolidated with a mixture comprising from 10 to 100 parts by weight of at least one aluminum hydroxide per 100 parts by weight of at least one polymeric binder.

7. The roofing membrane according to any one of claims 1 to 6 wherein the fibrous web consists of polyester fiber or of a blend of polyester fibers and glass fibers.

8. The roofing membrane according to any one of claims 1 to 7 wherein the polymeric binder comprises a thermally crosslinkable addition copolymer of acrylic esters, styrene and acrylonitrile in combination with a urea-formaldehyde resin and/or a melamine-formaldehyde resin.

9. The use of a bonded fibrous web consolidated with a mixture of at least one polymeric binder and at least one aluminum hydroxide as a base material for a bituminized roofing membrane.
